(19) United States
(12) Patent Application Publication
(10) Pub. No.: US 2021/0041021 A1
(43) Pub. Date: Feb. 11, 2021

(54) MULTI-VARIATOR HYDROSTATIC TRANSMISSION

(71) Applicant: Caterpillar Inc., Deerfield, IL (US)

(72) Inventors: Paul A. DVORAK, SR., Peoria, IL (US); Corwin E. STORER, Bartonville, IL (US); Kraig M. LOVE, Washington, IL (US)

(73) Assignee: Caterpillar Inc., Deerfield, IL (US)

(21) Appl. No.: 16/534,926

(22) Filed: Aug. 7, 2019

(51) Int. Cl. F16H 61/433; F16H 47/04; F16H 61/662

(52) U.S. Cl. CPC F16H 61/433; F16H 61/66236; F16H 47/04

(57) ABSTRACT

A system is disclosed. The system may include a first hydraulic variator including a first hydraulic pump and a first hydraulic motor. A first actuator may be linked to the first hydraulic pump. The first actuator may be associated with a feedback link configured to control pressure supplied to the first actuator, via a control valve, according to the displacement of the first hydraulic pump. The system may include a second hydraulic variator including a second hydraulic pump and a second hydraulic motor. A second actuator may be linked to the second hydraulic pump and configured to control a pressure within the second hydraulic variator to correspond to a pressure within the first hydraulic variator. The system may include a controller configured to provide a first signal to the first hydraulic variator relating to a speed and a second signal to the second hydraulic variator relating to a torque.

### TECHNICAL FIELD

The present disclosure relates generally to hydrostatic transmissions and more particularly to a multi-variator hydrostatic transmission.

### BACKGROUND

A hydrostatic transmission may be used in a heavy machine, such as a construction machine or an agricultural machine, to deliver power from a power source, such as an engine, to a drivetrain of the heavy machine. The hydrostatic transmission may include one or more variators, each including a hydraulic motor paired with a hydraulic pump. The variators may be configured so as to provide continuously variable torque and speed to the drivetrain of the heavy machine, thus allowing the power source to operate at a particular operating mode (e.g., an optimal range of revolutions per minute (RPM) or an optimal fuel consumption rate) according to power requirements of the heavy machine.

However, in order for a multi-variator hydrostatic transmission to operate efficiently, each of the variators must operate in cooperation with the other. Otherwise, even slight mismatches in the outputs of the variators may cause the variators to work against each other, thereby reducing the efficiency and/or the stability of the hydrostatic transmission.

One attempt at a multi-variator transmission is disclosed in U.S. Pat. No. 9,803,749 that issued to Caterpillar Inc. on Oct. 31, 2017 (“the '749 patent”). In particular, the '749 patent discloses a hydrostatic transmission using hydraulically coupled multi-variator actuation. The '749 patent indicates that the actuators controlling each of the hydraulic pumps of each variator may be hydraulically linked to facilitate coordinated operation of each of the variators. Specifically, the '749 patent states that the transfer of hydraulic pressure from one actuator to another, and vice versa, via the hydraulic link may serve to cause synchronized movement of the actuators and equal displacement of the pumps.

The multi-variator hydrostatic transmission of the present disclosure solves one or more of the problems set forth above and/or other problems in the art.

### SUMMARY

According to some implementations, a method may include providing, by a controller, a first signal relating to a speed that is to be provided by a first hydraulic variator of a transmission, the first signal causing a displacement of a hydraulic pump of the first hydraulic variator; detecting, by the controller, a first pressure within the first hydraulic variator as a result of the displacement; and providing, by the controller, a second signal relating to a second pressure that is to be produced within a second hydraulic variator of the transmission, the second signal being based on the first pressure that is detected, and the second signal causing the second pressure within the second hydraulic variator to correspond to the first pressure that is detected.

According to some implementations, a system may include a first hydraulic variator including a first hydraulic pump and a first hydraulic motor linked to the first hydraulic pump; a first actuator linked to the first hydraulic pump and configured to control a displacement of the first hydraulic pump, the first actuator being associated with a feedback link configured to control pressure supplied to the first actuator, via a control valve, according to the displacement of the first hydraulic pump; a second hydraulic variator including a second hydraulic pump and a second hydraulic motor linked to the second hydraulic pump; a second actuator linked to the second hydraulic pump and configured to control a pressure within the second hydraulic variator to correspond to a pressure within the first hydraulic variator; and a controller configured to provide a first signal to the first hydraulic variator relating to a speed that is to be produced by the first hydraulic variator, and to provide a second signal to the second hydraulic variator relating to a torque that is to be produced by the second hydraulic variator.

According to some implementations, a continuously variable transmission may include a planetary gear arrangement; and a hydrostatic transmission having an input and an output, the output of the hydrostatic transmission being connected to the planetary gear arrangement, the hydrostatic transmission including: a first hydraulic variator including a first hydraulic pump and a first hydraulic motor linked to the first hydraulic pump; a first actuator linked to the first hydraulic pump and configured to control a displacement of the first hydraulic pump, the first actuator being associated with a feedback link configured to control pressure supplied to the first actuator, via a control valve, according to the displacement of the first hydraulic pump; a second hydraulic variator including a second hydraulic pump and a second hydraulic motor linked to the second hydraulic pump; and a second actuator linked to the second hydraulic pump and configured to control a pressure within the second hydraulic variator to correspond to a pressure within the first hydraulic variator.

### BRIEF DESCRIPTION OF THE DRAWINGS

FIG. 1 is diagram of an example hydrostatic transmission described herein.

FIG. 2 is a diagram of an example implementation described herein.

FIG. 3 is a diagram of an example split power continuously variable transmission that includes the hydrostatic transmission of FIG. 1.

FIG. 4 is a flowchart of an example process for controlling a multi-variator hydrostatic transmission.

### DETAILED DESCRIPTION

This disclosure relates to a multi-variator hydrostatic transmission. The multi-variator hydrostatic transmission may be included on various machines, such as vehicles, construction machines (e.g., dozers, motor graders, and/or the like) agricultural machines (e.g., agricultural tractors, harvesters, and/or the like), watercraft (e.g., tugboats, cargo ships, and/or the like), and/or the like.

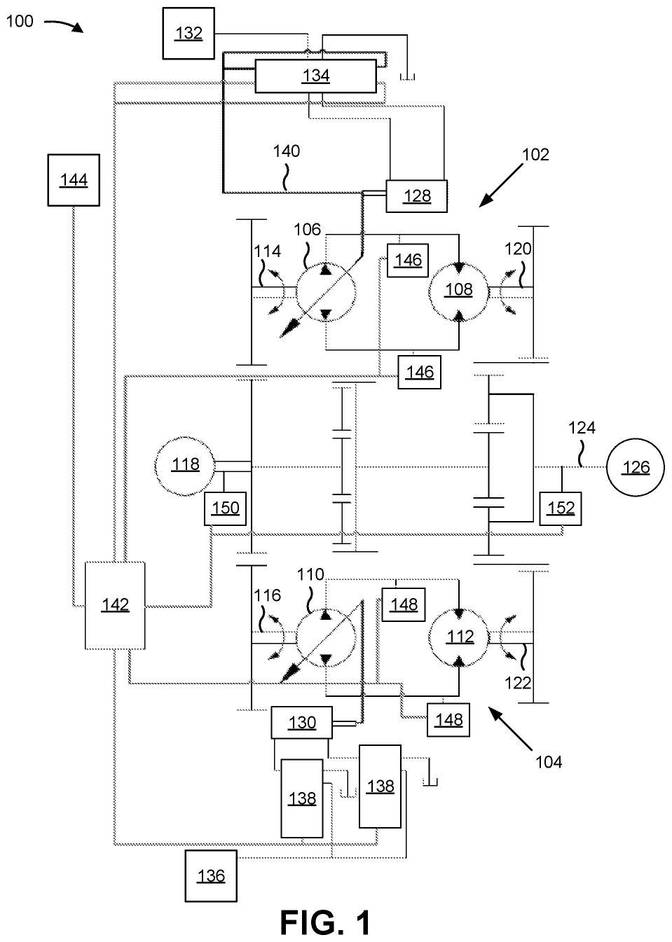

FIG. 1 is a diagram of an example hydrostatic transmission 100 described herein. As shown in FIG. 1, the hydrostatic transmission 100 may include a first hydraulic variator 102 (e.g., a primary hydraulic variator) and a second hydraulic variator 104 (e.g., a secondary hydraulic variator). Although the example hydrostatic transmission 100 is shown with two hydraulic variators, the hydrostatic transmission 100 may include more than two hydraulic variators. For example, the hydrostatic transmission 100 may include multiple second hydraulic variators 104 that are associated with the first hydraulic variator 102.

The first hydraulic variator 102 may include a first hydraulic pump 106. The first hydraulic pump 106 may be a variable displacement hydraulic pump and may have a swash plate. As an example, the first hydraulic pump 106 may be, or include, an axial piston pump and may have a swash plate. In such a case, an angle of the swash plate of the first hydraulic pump 106 may be adjusted to change a displacement of the first hydraulic pump 106. The first hydraulic variator 102 may also include a first hydraulic motor 108, which may be hydraulically connected to the first hydraulic pump 106. As an example, the first hydraulic motor 108 may be a fixed displacement hydraulic motor.

The second hydraulic variator 104 may include a second hydraulic pump 110, similar to that described above in connection with the first hydraulic pump 106. The second hydraulic variator 104 may include a second hydraulic motor 112, similar to that described above in connection with the first hydraulic motor 108. The second hydraulic motor 112 may be hydraulically connected to the second hydraulic pump 110.

The first hydraulic pump 106 and the second hydraulic pump 110 may receive a power input via a first input shaft 114 and a second input shaft 116, respectively. A power source 118, such as an internal combustion engine of a machine (e.g., a machine that includes hydrostatic transmission 100), may provide a common input to the first input shaft 114 and the second input shaft 116. The common input may be split (e.g., by a gear set) into two or more inputs. For example, a gear set may split the power of the common input equally between the two or more inputs. As an example, the gear set may split the power of the common input equally between two inputs, which may drive the first input shaft 114 and the second input shaft 116, respectively.

The first input shaft 114 may power the first hydraulic pump 106 of the first hydraulic variator 102 to produce an output via a first output shaft 120. The second input shaft 116 may power the second hydraulic pump 110 of the second hydraulic variator 104 to produce an output via a second output shaft 122. The first output shaft 120 and the second output shaft 122 may be mechanically tied via a gear set to produce a common output 124 (e.g., the first hydraulic variator 102 and the second hydraulic variator 104 may be arranged in parallel). The common output 124 may be used to power a drivetrain 126, or other application, of the machine that includes hydrostatic transmission 100. The drivetrain 126 may be mechanically linked to a propulsive means of the machine, such as wheels or tracks. Additionally, or alternatively, the common output 124 may be used to power an implement of the machine, such as a bucket, a lifting device, a boom, an auger, and/or the like.

As respective displacements of the first hydraulic pump 106 and the second hydraulic pump 110 are varied according to respective swash plates of the first hydraulic pump 106 and the second hydraulic pump 110, respective speeds and/or torques of the first hydraulic motor 108 and the second hydraulic motor 112 may be controlled. Thus, a speed and/or a torque of the common output 124 may be regulated to accommodate various operating parameters while still maintaining a relatively constant speed and/or torque at the power source 118.

The swash plate of the first hydraulic pump 106 may be mechanically linked to a first actuator 128 to effectuate adjustment of the swash plate. Similarly, the swash plate of the second hydraulic pump 110 may be mechanically linked to a second actuator 130 to effectuate adjustment of the swash plate. The first actuator 128 and/or the second actuator 130 may be, or include, a hydraulic actuator. The hydraulic actuator may include a cylinder and a movable piston within the cylinder. The hydraulic actuator may be double-acting, such that hydraulic pressure may be applied to either side of the piston within the cylinder, and the difference in pressure between the sides may effectuate movement of the piston within the cylinder.

A first hydraulic supply pump 132 may supply hydraulic pressure (e.g., via hydraulic fluid) to the first actuator 128 via a hydraulic channel that is controlled by a first control valve 134. A second hydraulic supply pump 136 may supply hydraulic pressure to the second actuator 130 via a hydraulic channel that is controlled by a second control valve 138. The first control valve 134 and/or the second control valve 138 may include a single four-way valve or two three-way valves.

The first actuator 128 and the first control valve 134 may be connected by a feedback link 140 (e.g., a mechanical link) that provides displacement feedback. For example, the feedback link 140 may be a mechanical feedback control (e.g., a servo feedback control) that provides a control loop between the first actuator 128 and the first control valve 134, to thereby control a displacement of the first hydraulic pump 106. Accordingly, as the swash plate of the first hydraulic pump 106 achieves a position that produces a displacement of the first hydraulic pump 106 that corresponds to a target displacement, a corresponding movement of the first actuator 128 causes the first control valve 134 to close via the feedback link 140. Similarly, as the swash plate of the first hydraulic pump 106 moves away from a position that produces a displacement of the first hydraulic pump 106 that corresponds to a target displacement, a corresponding movement of the first actuator 128 causes the first control valve 134 to open via the feedback link 140 until the swash plate of the first hydraulic pump 106 returns to the position.

In some implementations, the second hydraulic variator 104 does not include such a feedback link. For example, the second actuator 130 and the second control valve 138 of the second hydraulic variator 104 may not be connected by such a feedback link.

The first control valve 134 and the second control valve 138 may each be communicatively connected to a controller 142, which controls the operation of the first control valve 134 and/or the second control valve 138, to thereby control the first actuator 128 and/or the second actuator 130, respectively, according to an operator command from a machine operator. Accordingly, the controller 142 may be communicatively connected to an input 144, such as a lever, a pedal, a throttle, and/or the like that may be manipulated by the machine operator to effectuate the operation of the machine. For example, the machine operator may manipulate input 144 to adjust a speed of the machine.

The controller 142 may monitor one or more operational aspects of the hydrostatic transmission 100, such as a pump loop pressure, a pump loop flow, an output torque, an output speed, and/or the like, of the first hydraulic variator 102 and/or the second hydraulic variator 104. The one or more operational aspects may be monitored via one or more sensors included in the controller 142 or otherwise disposed in the hydrostatic transmission 100. For example, one or more first pressure sensors 146 may be associated with (e.g., disposed in) a connection (e.g., a hydraulic link) between the first hydraulic pump 106 and the first hydraulic motor 108 (e.g., to detect a pressure of the first hydraulic variator 102), and one or more second pressure sensors 148 may be associated with a connection between the second hydraulic pump 110 and the second hydraulic motor 112 (e.g., to detect a pressure of the second hydraulic variator 104). As another example, one or more first speed sensors 150 may be associated with the power source 118 and/or the common input associated with the power source 118 (e.g., to detect an input speed of the hydrostatic transmission 100), and one or more second speed sensors 152 may be associated with the common output 124 and/or the drivetrain 126 (e.g., to detect an output speed of the hydrostatic transmission 100).

The controller 142 may alter the operation of the first control valve 134 and/or the second control valve 138 according to the one or more operational aspects of the hydrostatic transmission 100. For example, if the controller 142 determines that the pump loop pressure of the first hydraulic variator 102 (e.g., according to the one or more first pressure sensors 146) is higher than the pump loop pressure of the second hydraulic variator 104 (e.g., according to the one or more second pressure sensors 148), the controller 142 may operate the second control valve 138 so that the second actuator 130 positions the swash plate of the second hydraulic pump 110 to increase the displacement of the second hydraulic pump 110, thereby increasing the pump loop pressure of the second hydraulic variator 104 to match that of the first hydraulic variator 102. As another example, if the controller 142 determines that the output speed of the hydrostatic transmission 100 (e.g., according to the one or more second speed sensors 152) is lower than an operator command relating to a speed that is to be provided by the hydrostatic transmission 100, the controller 142 may operate the first control valve 134 so that the first actuator 128 positions the swash plate of the first hydraulic pump 106 to increase the displacement of the first hydraulic pump 106, thereby increasing the speed that is produced by the first hydraulic variator 102.

As indicated above, FIG. 1 is provided as an example. Other examples may differ from what is described in connection with FIG. 1.

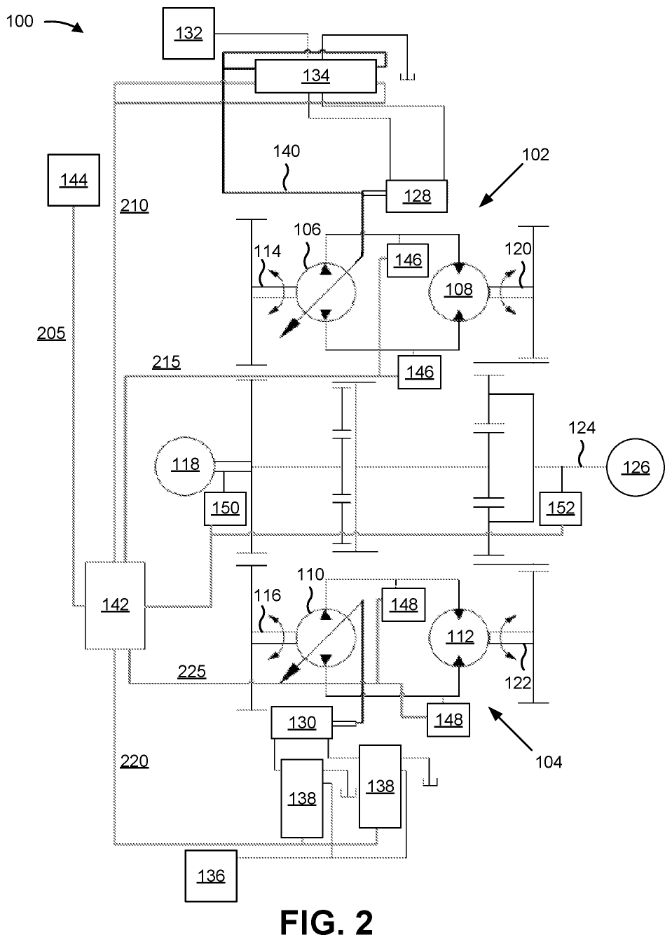

FIG. 2 is a diagram of an example implementation described herein. As shown in FIG. 2, and by reference number 205, the controller 142 may receive an operator command provided by an operator of the machine. The operator command may be a command to increase a speed of the machine (e.g., increase an output speed of hydrostatic transmission 100), decrease a speed of the machine, and/or the like.

The controller 142 may be an electronic control module associated with hydrostatic transmission 100. The controller 142 may include one or more processors and one or more memories to implement software that provides control of the hydrostatic transmission 100 as described herein.

As shown by reference number 210, the controller 142 may provide a speed command signal to the first hydraulic variator 102. For example, the controller 142 may provide a speed command signal to the first hydraulic variator 102 based on the operator command. The speed command signal may relate to a target displacement that is to be produced by the first hydraulic pump 106 (e.g., a target displacement corresponding to a speed that is to be produced by the first hydraulic variator 102 at the first output shaft 120).

In some implementations, the controller 142 does not provide a speed command signal to the second hydraulic variator 104. Accordingly, an output speed at the common output 124 may be controlled by an output speed at the first output shaft 120 of the first hydraulic variator 102. For example, an output speed at the common output 124 may be provided by the first output shaft 120 of the first hydraulic variator 102.

The speed command signal may cause an adjustment in a position of the first control valve 134 (e.g., according to the speed command signal), to thereby reduce or increase pressure (e.g., hydraulic pressure) supplied to the first actuator 128 by the first hydraulic supply pump 132. The pressure supplied to the first actuator 128 permits the first actuator 128 to control a position (e.g., an angle) of the swash plate of the first hydraulic pump 106, to thereby achieve a displacement of the first hydraulic variator 102 (e.g., a displacement of the first hydraulic pump 106) in accordance with the speed command signal. Maintenance of the displacement of the first hydraulic pump 106 at or near a target displacement (e.g., in accordance with the speed command signal) may be provided by feedback link 140. Thus, the first hydraulic pump 106 may be considered a feedback-controlled pump (e.g., a speed-controlled pump).

As shown by reference number 215, the one or more first pressure sensors 146 may provide information relating to a pressure of the first hydraulic variator 102 to the controller 142. For example, the one or more first pressure sensors 146 may detect a pump loop pressure associated with the first hydraulic variator 102, and may provide information relating to the detected pump loop pressure to the controller 142.

A particular pressure of the first hydraulic variator 102 may result from a particular position of the swash plate of the first hydraulic pump 106. In other words, the particular position of the swash plate that is provided to produce a particular displacement may also produce the particular pressure. The particular pressure produced within the first hydraulic variator 102 may provide a particular torque of the first hydraulic variator 102 (e.g., at the first output shaft 120).

As shown by reference number 220, the controller 142 may obtain the information relating to the pressure of the first hydraulic variator 102 and may provide a torque command signal to the second hydraulic variator 104. For example, the controller 142 may provide a torque command signal to the second hydraulic variator 104 that is based on the pressure of the first hydraulic variator 102 (e.g., the torque command signal may relate to a pressure that corresponds to the pressure of the first hydraulic variator 102). The torque command signal may relate to a target pressure that is to be produced by the second hydraulic pump 110 (e.g., a target pressure corresponding to a torque that is to be produced by the second hydraulic variator 104 at the second output shaft 122). In some implementations, the controller 142 does not provide a torque command signal to the first hydraulic variator 102.

The torque command signal may cause an adjustment in a position of the second control valve 138 (e.g., according to the torque command signal), to thereby reduce or increase pressure (e.g., hydraulic pressure) supplied to the second actuator 130 by the second hydraulic supply pump 136. The pressure supplied to the second actuator 130 permits the second actuator 130 to control a position (e.g., an angle) of the swash plate of the second hydraulic pump 110, to thereby achieve a pressure of the second hydraulic variator 104 (e.g., a pressure of the second hydraulic pump 110) in accordance with the torque command signal. The pressure of the second hydraulic variator 104 may provide a torque of the second hydraulic variator 104 that corresponds to a torque of the first hydraulic variator 102.

The particular pressure produced within the second hydraulic variator 104 may be associated with a particular displacement of the second hydraulic pump 110. However, as described above, in some implementations, the second hydraulic variator 104 is not associated with a feedback link between the second actuator 130 and the second control valve 138 that maintains the displacement of the second hydraulic pump 110. Rather, the displacement of the second hydraulic pump 110 may be maintained by pressure on a first side of the swash plate of the second hydraulic pump 110 provided by the second actuator 130, and system pressure of the second hydraulic variator 104 on a second side of the swash plate. Accordingly, the second hydraulic pump 110 may be considered a non-feedback-controlled pump (e.g., a torque-controlled pump).

As shown by reference number 225, the one or more second pressure sensors 148 may provide information relating to a pressure of the second hydraulic variator 104 to the controller 142. For example, the one or more second pressure sensors 148 may detect a pump loop pressure associated with the second hydraulic variator 104, and may provide information relating to the detected pump loop pressure to the controller 142.

Based on the information relating to the pressure of the second hydraulic variator 104, the controller 142 may modify the torque command signal to the second hydraulic variator 104 to cause the second hydraulic variator 104 to increase or decrease the pressure within the second hydraulic variator 104. For example, if the information relating to the pressure of the second hydraulic variator 104 indicates that the pressure of the second hydraulic variator 104 is below the detected pressure of the first hydraulic variator 102, the modified torque command signal may cause the second hydraulic variator 104 to increase the pressure.

The controller 142 may continue to modify the torque command signal to the second hydraulic variator 104, based on the detected pressure of the first hydraulic variator 102, until the pressure of the first hydraulic variator 102 and the pressure of the second hydraulic variator 104 are balanced (that is, until the pressure of the second hydraulic variator 104 corresponds to the pressure of the first hydraulic variator 102). The controller 142 may determine that the pressure of the first hydraulic variator 102 and the pressure of the second hydraulic variator 104 correspond when the pressures are within a threshold tolerance of each other (e.g., ±1%, ±5%, and/or the like).

As indicated above, FIG. 2 is provided as an example. Other examples may differ from what is described in connection with FIG. 2.

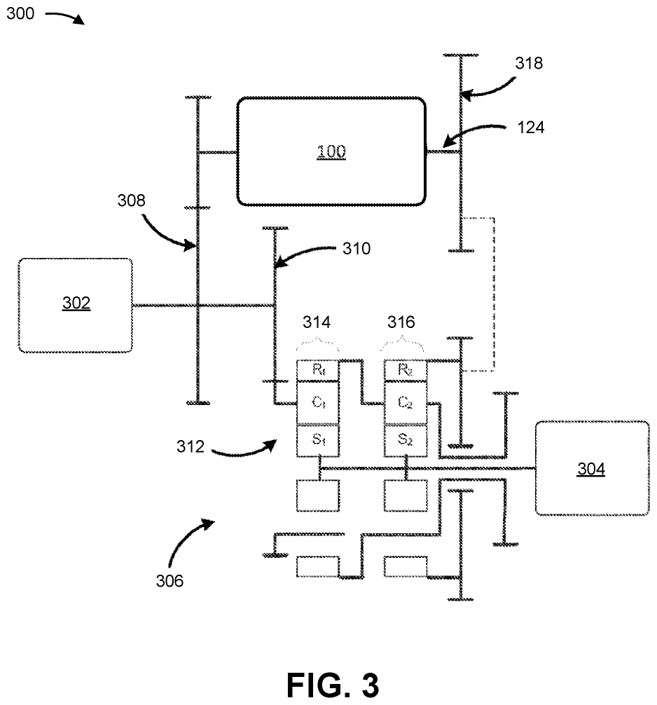

FIG. 3 is a diagram of an example of a split power continuously variable transmission (CVT) 300. As shown in FIG. 3, the hydrostatic transmission 100 may be included as a component of the split power CVT 300. The split power CVT 300 may include two parallel paths of power transmission from an input 302 to an output 304. A first path of power transmission may be associated with the hydrostatic transmission 100, and a second path of power transmission may be associated with a mechanical transmission 306. The split power CVT 300 may have the input 302 mechanically linked to an engine and the output 304 mechanically linked to a downstream gear train. The input 302 may be connected to an input gear set 308 that may power the hydrostatic transmission 100. The input 302 may also be connected to a mechanical transmission input gear 310 that may power the mechanical transmission 306. The mechanical transmission 306 may include a planetary gear arrangement 312 with a first planetary gear set 314 and a second planetary gear set 316. The first planetary gear set 314 of the planetary gear arrangement 312 may be connected to and receive power input from the mechanical transmission input gear 310. The second planetary gear set 316 of the planetary gear arrangement 312 may be connected to the common output 124, via a common output gear 318, of the hydrostatic transmission 100. Accordingly, a first output of the first hydraulic variator 102 and a second output of the second hydraulic variator 104 may be directed to a same planetary gear set (e.g., the second planetary gear set 316) of the planetary gear arrangement 312.

In operation, the planetary gear arrangement 312 may combine the hydrostatic output power from the hydrostatic transmission 100 with the split input mechanical power to provide hydro-mechanical output power for application to a load, such as the propulsive means of the machine or an implement disposed thereon. As a result, the speed and the torque in each of the power ranges initially set by gear ratios of the planetary gear arrangement 312 may be continuously varied by varying the displacements of the first hydraulic pump 106 and/or the second hydraulic pump 110 of the hydrostatic transmission 100.

As indicated above, FIG. 3 is provided as an example. Other examples may differ from what is described in connection with FIG. 3.

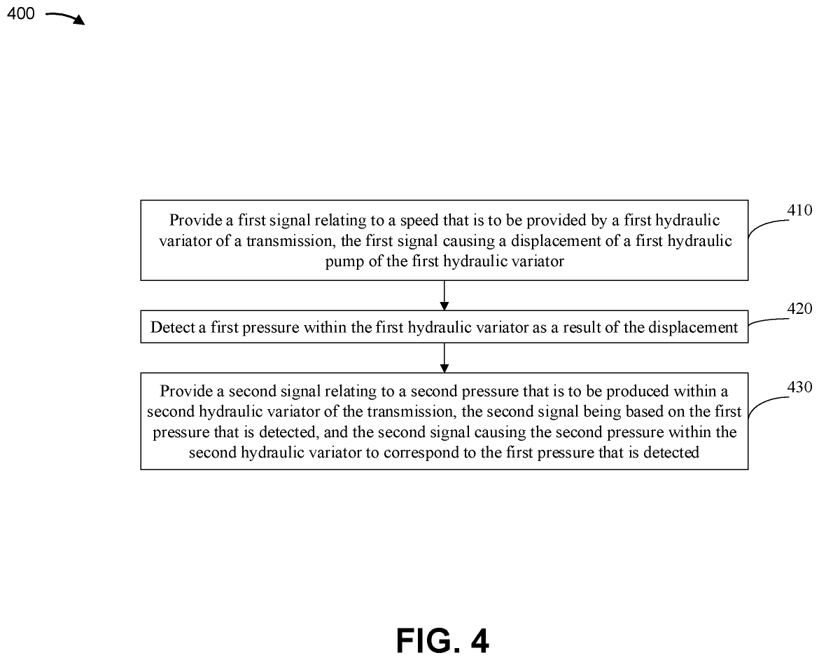

FIG. 4 is a flowchart of an example process 400 for controlling a multi-variator hydrostatic transmission. One or more process blocks of FIG. 4 may be performed by a controller (e.g., controller 142). Additionally, or alternatively, one or more process blocks of FIG. 4 may be performed by another device or a group of devices separate from or including the controller, such as a hydrostatic transmission (e.g., hydrostatic transmission 100), a pressure sensor (e.g., the one or more first pressure sensors 146 and/or the one or more second pressure sensors 148), and/or another device or component that is internal or external to a machine that includes the hydrostatic transmission.

As shown in FIG. 4, process 400 may include providing a first signal relating to a speed that is to be provided by a first hydraulic variator of a transmission, the first signal causing a displacement of a hydraulic pump of the first hydraulic variator (block 410). The first signal may be based on a command provided by an operator of a machine associated with the transmission.

The first hydraulic variator may include a feedback link (e.g., a mechanical servo feedback link) between an actuator of the first hydraulic variator and a control valve of the first hydraulic variator. Accordingly, the displacement of the first hydraulic variator may be controlled according to the feedback link. For example, the feedback link may be configured to control pressure supplied to the actuator, via the control valve, according to whether the displacement of the hydraulic pump corresponds to a target displacement. The target displacement may be based on the speed that is to be produced by the first hydraulic variator.

As further shown in FIG. 4, process 400 may include detecting a first pressure within the first hydraulic variator as a result of the displacement (block 420). Thus, the first hydraulic variator may be associated with one or more first pressure sensors configured to provide information relating to the pressure within the first hydraulic variator to the controller, and the second hydraulic variator may be associated with one or more second pressure sensors configured to provide information relating to the pressure within the second hydraulic variator to the controller.

As further shown in FIG. 4, process 400 may include providing a second signal relating to a second pressure that is to be produced within a second hydraulic variator of the transmission, the second signal being based on the first pressure that is detected, and the second signal causing the second pressure within the second hydraulic variator to correspond to the first pressure that is detected (block 430). The second pressure within the second hydraulic variator may be controlled according to a pressure sensor. For example, an actuator of the second hydraulic variator may be configured to control the pressure within the second hydraulic variator by increasing the pressure within the second hydraulic variator, as detected by the pressure sensor, until the pressure within the second hydraulic variator corresponds to the pressure within the first hydraulic variator.

Moreover, controlling the pressure of the second hydraulic variator may control a torque of the second hydraulic variator to correspond to a torque of the first hydraulic variator. Thus, in some cases, the second signal to the second hydraulic variator may relate to a torque that is to be produced by the second hydraulic variator according to a target pressure.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

The disclosed hydrostatic transmission 100 may be used in any application in which a transmission is used to link a power source to a work load. In particular, the disclosed hydrostatic transmission 100 may be used in any application in which continuously varying a speed and/or a torque of a transmission output is desired. For example, the disclosed hydrostatic transmission 100 may be used in a heavy machine, such as a heavy machine used for mining, construction, farming, transportation, and/or the like.

The disclosed hydrostatic transmission 100 may facilitate efficient operation of multiple variators (e.g., dual variators) included in the hydrostatic transmission 100. For example, the hydrostatic transmission 100 may include a first hydraulic variator 102 that serves as a primary hydraulic variator and a second hydraulic variator 104 that serves as a secondary hydraulic variator. Speed command signals from the controller 142 are sent to the primary hydraulic variator, while torque command signals from the controller 142, that are based on a pressure of the primary hydraulic variator, are sent to the secondary hydraulic variator. In this way, coordinated control of the primary hydraulic variator and the secondary hydraulic variator is achieved by balancing pressures of the primary hydraulic variator and the secondary hydraulic variator. Accordingly, the hydrostatic transmission 100 achieves improved efficiency and performance by reducing or eliminating “fighting” between the primary hydraulic variator and the secondary hydraulic variator that may otherwise occur when outputs of the variators are mismatched.

What is claimed is:

1. A method, comprising:
providing, by a controller, a first signal relating to a speed that is to be provided by a first hydraulic variator of a transmission,
the first signal causing a displacement of a hydraulic pump of the first hydraulic variator;
detecting, by the controller, a first pressure within the first hydraulic variator as a result of the displacement; and
providing, by the controller, a second signal relating to a second pressure that is to be produced within a second hydraulic variator of the transmission,
the second signal being based on the first pressure that is detected,
the second signal causing the second pressure within the second hydraulic variator to correspond to the first pressure that is detected.

2. The method of claim 1, wherein the first hydraulic variator includes a feedback link between an actuator of the first hydraulic variator and a control valve of the first hydraulic variator.

3. The method of claim 1, wherein the displacement of the first hydraulic variator is controlled according to a feedback link, and the second pressure within the second hydraulic variator is controlled according to a pressure sensor.

4. The method of claim 1, wherein the hydraulic pump of the first hydraulic variator is a feedback-controlled pump and a hydraulic pump of the second hydraulic variator is a non-feedback-controlled pump.

5. The method of claim 1, wherein the second pressure provides a torque of the second hydraulic variator that corresponds to a torque of the first hydraulic variator.

6. The method of claim 1, wherein the first signal is based on a command provided by an operator of a machine associated with the transmission.

7. A system, comprising:
a first hydraulic variator including a first hydraulic pump and a first hydraulic motor linked to the first hydraulic pump;
a first actuator linked to the first hydraulic pump and configured to control a displacement of the first hydraulic pump,
the first actuator being associated with a feedback link configured to control pressure supplied to the first actuator, via a control valve, according to the displacement of the first hydraulic pump;
a second hydraulic variator including a second hydraulic pump and a second hydraulic motor linked to the second hydraulic pump;
a second actuator linked to the second hydraulic pump and configured to control a pressure within the second hydraulic variator to correspond to a pressure within the first hydraulic variator; and
a controller configured to provide a first signal to the first hydraulic variator relating to a speed that is to be produced by the first hydraulic variator, and to provide a second signal to the second hydraulic variator relating to a torque that is to be produced by the second hydraulic variator.

8. The system of claim 7, wherein the feedback link provides a link between the first actuator and the control valve.

9. The system of claim 7, wherein the feedback link is configured to control pressure supplied to the first actuator, via the control valve, according to whether the displacement of the first hydraulic pump corresponds to a target displacement.

10. The system of claim 9, wherein the target displacement is based on the speed that is to be produced by the first hydraulic variator.

11. The system of claim 7, wherein the first signal to the first hydraulic variator relates to the speed that is to be produced by the first hydraulic variator according to a target displacement, and
wherein the second signal to the second hydraulic variator relates to the torque that is to be produced by the second hydraulic variator according to a target pressure.

12. The system of claim 7, wherein the first hydraulic variator is associated with one or more first pressure sensors configured to provide information relating to the pressure within the first hydraulic variator to the controller, and the second hydraulic variator is associated with one or more second pressure sensors configured to provide information relating to the pressure within the second hydraulic variator to the controller.

13. The system of claim 7, wherein controlling the pressure of the second hydraulic variator controls a torque of the second hydraulic variator to correspond to a torque of the first hydraulic variator.

14. A continuously variable transmission, comprising:
a planetary gear arrangement; and
a hydrostatic transmission having an input and an output,
the output of the hydrostatic transmission being connected to the planetary gear arrangement,
the hydrostatic transmission including:
a first hydraulic variator including a first hydraulic pump and a first hydraulic motor linked to the first hydraulic pump;
a first actuator linked to the first hydraulic pump and configured to control a displacement of the first hydraulic pump,
the first actuator being associated with a feedback link configured to control pressure supplied to the first actuator, via a control valve, according to the displacement of the first hydraulic pump;
a second hydraulic variator including a second hydraulic pump and a second hydraulic motor linked to the second hydraulic pump; and
a second actuator linked to the second hydraulic pump and configured to control a pressure within the second hydraulic variator to correspond to a pressure within the first hydraulic variator.

15. The continuously variable transmission of claim 14, wherein the feedback link is a mechanical servo feedback link.

16. The continuously variable transmission of claim 14, wherein the feedback link provides a link between the first actuator and the control valve.

17. The continuously variable transmission of claim 14, wherein the second actuator is configured to control the pressure within the second hydraulic variator by increasing the pressure within the second hydraulic variator until the pressure within the second hydraulic variator corresponds to the pressure within the first hydraulic variator.

18. The continuously variable transmission of claim 14, wherein the control valve is a first control valve, and
wherein pressure is supplied to the second actuator via a second control valve.

19. The continuously variable transmission of claim 14, wherein controlling the pressure of the second hydraulic variator controls a torque of the second hydraulic variator to correspond to a torque of the first hydraulic variator.

20. The continuously variable transmission of claim 14, wherein a first output of the first hydraulic variator and a second output of the second hydraulic variator are directed to a same planetary gear set of the planetary gear arrangement.
